(19) United States
(12) Patent Application Publication
(10) Pub. No.: US 2026/0189427 A1
(43) Pub. Date: Jul. 2, 2026

(54) IN-VEHICLE DEVICE, COMMUNICATION SYSTEM, AND COMMUNICATION STABILIZATION METHOD

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventors: Nobuyuki KOBAYASHI, Yokkaichi-Shi, Mie (JP); Makoto MASHITA, Yokkaichi-Shi, Mie (JP); Masakatsu MORIGUCHI, Yokkaichi-Shi, Mie (JP); Masaki KONDO, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/861,244

(22) PCT Filed: Apr. 27, 2023
(86) PCT No.: PCT/JP2023/016638

§ 371 Date: Oct. 29, 2024

(30) Foreign Application Priority Data
May 2, 2022 (JP) 2022-076292

(51) Int. Cl. H04L 12/40

(52) U.S. Cl. CPC H04L 12/40006; H04L 2012/40273

(57) ABSTRACT

An in-vehicle device constituting a node of a communication system that performs data communication between nodes via a bus includes a bit communicator configured to adjust a termination resistance value of a variable termination circuit that avoids reflection of a signal constituting data.

### CROSS-REFERENCE TO RELATED APPLICATIONS

This application is the U.S. national stage of PCT/JP2023/016638 filed on Apr. 27, 2023, which claims priority of Japanese Patent Application No. JP 2022-076292 filed on May 2, 2022, the contents of which are incorporated herein.

### TECHNICAL FIELD

The present disclosure relates to an in-vehicle device including a substrate, a communication system, and a communication stabilization method.

### BACKGROUND

JP 2016-213653A discloses a communication system in which a plurality of communication devices are connected to a communication bus. This communication system is installed in a vehicle. Each communication device transmits data to other communication devices via the communication bus.

Disconnection in a communication system presumably occurs for a reason. In this case, there is a likelihood that normal communication will no longer be possible due to reflection of the signal constituting data (hereinafter, simply referred to as signal reflection). However, with the communication system described in JP 2016-213653A, such problems are not taken into consideration and cannot be resolved.

In view of this, an object is to provide an in-vehicle device, a communication system, and a communication stabilization method that enable normal data communication between communicative nodes, when disconnection occurs in a communication system having a plurality of nodes.

### SUMMARY

An in-vehicle device according to an embodiment of the present disclosure is an in-vehicle device constituting a node of a communication system that performs data communication between nodes via a bus, including a communication unit, in which the communication unit is configured to adjust a termination resistance value of a termination circuit.

A communication system according to an embodiment of the present disclosure is a communication system including a plurality of in-vehicle devices that perform data communication via a bus, in which each in-vehicle device includes a communication unit configured to adjust a termination resistance value of a termination circuit, one of the in-vehicle devices includes a storage unit configured to store connection situation information relating to a connection situation of the plurality of in-vehicle devices with respect to the bus, and the one in-vehicle device specifies a disconnection location based on the connection situation information, when disconnection occurs in the communication system, and outputs an instruction to adjust the terminal resistance value to another of the in-vehicle devices closer to the one in-vehicle device than is the disconnection location.

A communication stabilization method according to an embodiment of the present disclosure is a communication stabilization method in a communication system including a plurality of in-vehicle devices that perform data communication via a bus and each include a communication unit configured to adjust a termination resistance value of a termination circuit, the method including specifying, with one of the in-vehicle devices, a disconnection location, based on connection situation information relating to a connection situation of the plurality of in-vehicle devices with respect to the bus, when disconnection occurs in the communication system, outputting, with the one in-vehicle device, an instruction to adjust the termination resistance value to another of the in-vehicle devices closer to the one in-vehicle device than is the disconnection location, and adjusting, with the other in-vehicle device, the terminal resistance value in response to the instruction.

### Advantageous Effects

According to the present disclosure, an in-vehicle device, a communication system, and a communication stabilization method that enable normal data communication between communicative nodes when disconnection occurs in a communication system having a plurality of nodes can be provided.

### BRIEF DESCRIPTION OF DRAWINGS

FIG. 1 is a block diagram showing the main configuration of a communication system of an embodiment.

FIG. 2 is a diagram for describing a method for transmitting frames in the communication system.

FIG. 3 is an order table showing a transmission order of frames in the communication system.

FIG. 4 is a waveform diagram showing an example of a waveform of a beacon signal.

FIG. 5 is a diagram for describing the contents of frames to be transmitted by 1st to 7th nodes.

FIG. 6 is a block diagram showing the main configuration of the 4th node of the communication system.

FIG. 7 is a circuit diagram of a bit communicator of the 4th node in the communication system.

FIG. 8 is a block diagram showing the main configuration of the 2nd node of the communication system.

FIG. 9 is a flowchart showing a procedure of transmission processing by an IC control unit of the 4th node.

FIG. 10 is a flowchart showing a procedure of transmission processing by the IC control unit of each of the 1st to 3rd nodes and the 5th to 7th nodes.

FIG. 11 is a flowchart showing a procedure of disconnection detection processing in the communication system.

### DETAILED DESCRIPTION OF PREFERRED EMBODIMENTS

Initially, embodiments of the present disclosure will be enumerated and described. Also, at least some of the embodiments described below may be combined in any desired manner.

An in-vehicle device according to an embodiment of the present disclosure is an in-vehicle device constituting a node of a communication system that performs data communication between nodes via a bus, including a communication unit, in which the communication unit is configured to adjust a termination resistance value of a termination circuit.

In this embodiment, when disconnection occurs in the communication system, for example, the in-vehicle device adjusts the termination resistance value of the termination circuit of the communication unit to avoid signal reflection and enables normal data communication between communicative nodes.

In the in-vehicle device according to an embodiment of the present disclosure, the communication unit includes a first termination circuit whose termination resistance value is constant, and a second termination circuit whose termination resistance value is variable, and the second termination circuit adjusts the termination resistance value to 0 Ω or a specific value.

In this embodiment, when disconnection occurs in the communication system, for example, the in-vehicle device adjusts the termination resistance value of the second termination circuit of the communication unit to 0 Ω or a specific value as appropriate to avoid signal reflection and enables normal data communication between communicative nodes.

In the in-vehicle device according to an embodiment of the present disclosure, the second termination circuit adjusts the termination resistance value to the specific value, in response to an adjustment instruction from outside when disconnection occurs in the communication system.

In this embodiment, when disconnection occurs in the communication system, for example, the in-vehicle device adjusts the termination resistance value of the second termination circuit of the communication unit to a specific value to avoid signal reflection, in response to an adjustment instruction from outside, and enables normal data communication between communicative nodes.

In the in-vehicle device according to an embodiment of the present disclosure, when the in-vehicle device is disposed closer to a predetermined in-vehicle device that outputs the adjustment instruction than is a disconnection location within the communication system, the second termination circuit adjusts the terminal resistance value to the specific value in response to the adjustment instruction.

In this embodiment, when disconnection occurs within the communication system, for example, the in-vehicle device, when closer to the predetermined in-vehicle device than is the disconnection location, adjusts the termination resistance value of the second termination circuit of the communication unit to a specific value to avoid signal reflection, in response to an adjustment instruction from the predetermined in-vehicle device, and enables normal data communication between communicative nodes.

In the in-vehicle device according to an embodiment of the present disclosure, the termination resistance value of the first termination circuit is the same resistance value as the other in-vehicle devices.

In this embodiment, the termination resistance value of the first termination circuit is the same in each in-vehicle device of the communication system, and thus the termination resistance of the entire device is affected by the second termination circuit. Accordingly, when disconnection occurs in the communication system, each in-vehicle device adjusts the termination resistance value of the second termination circuit of the communication unit as appropriate to avoid signal reflection and enables normal data communication between communitive nodes.

A communication system according to an embodiment of the present disclosure is a communication system including a plurality of in-vehicle devices that perform data communication via a bus, in which each in-vehicle device includes a communication unit configured to adjust a termination resistance value of a termination circuit, one of the in-vehicle devices includes a storage unit configured to store connection situation information relating to a connection situation of the plurality of in-vehicle devices with respect to the bus, and the one in-vehicle device specifies a disconnection location based on the connection situation information, when disconnection occurs in the communication system, and outputs an instruction to adjust the terminal resistance value to another of the in-vehicle devices closer to the one in-vehicle device than is the disconnection location.

In this embodiment, when disconnection occurs within the communication system, the one in-vehicle device specifies the disconnection location based on the connection situation information, and outputs an instruction to adjust the termination resistance value to another of the in-vehicle devices closer to the one in-vehicle device than is the specified disconnection location. In response to this instruction, the other in-vehicle device adjusts the termination resistance value of the termination circuit of the communication unit of the other in-vehicle device to avoid signal reflection and enables normal data communication between communicative nodes.

In the communication system according to an embodiment of the present disclosure, the one in-vehicle device detects disconnection of the communication system, by determining whether data transmitted to the bus by the plurality of in-vehicle devices in response to a beacon signal is received, based on a predetermined order.

In this embodiment, when disconnection of the communication system is detected, the one in-vehicle device is able to specify the disconnection location based on the connection situation information, by determining whether data transmitted to the bus by the plurality of in-vehicle devices in response to the beacon signal is received, based on the predetermined order.

A communication stabilization method according to an embodiment of the present disclosure is a communication stabilization method in a communication system including a plurality of in-vehicle devices that perform data communication via a bus and each include a communication unit configured to adjust a termination resistance value of a termination circuit, the method including specifying, with one of the in-vehicle devices, a disconnection location, based on connection situation information relating to a connection situation of the plurality of in-vehicle devices with respect to the bus, when disconnection occurs in the communication system, outputting, with the one in-vehicle device, an instruction to adjust the termination resistance value to another of the in-vehicle devices closer to the one in-vehicle device than is the disconnection location, and adjusting, with the other in-vehicle device, the terminal resistance value in response to the instruction.

In this embodiment, when disconnection occurs within the communication system, the one in-vehicle device specifies the disconnection location based on the connection situation information, and outputs an instruction to adjust the termination resistance value to another of the in-vehicle devices closer to the one in-vehicle device than is the specified disconnection location. In response to this instruction, the other in-vehicle device adjusts the termination resistance value of the termination circuit of the communication unit of the other in-vehicle device to avoid signal reflection and enables normal data communication between communicative nodes.

An in-vehicle device, a communication system, and a communication stabilization method according to an embodiment of the present disclosure will be described below with reference to the drawings. Note that the present disclosure is not limited to these illustrative examples and is defined by the claims, and all changes that come within the meaning and range of equivalency of the claims are intended to be embraced therein.

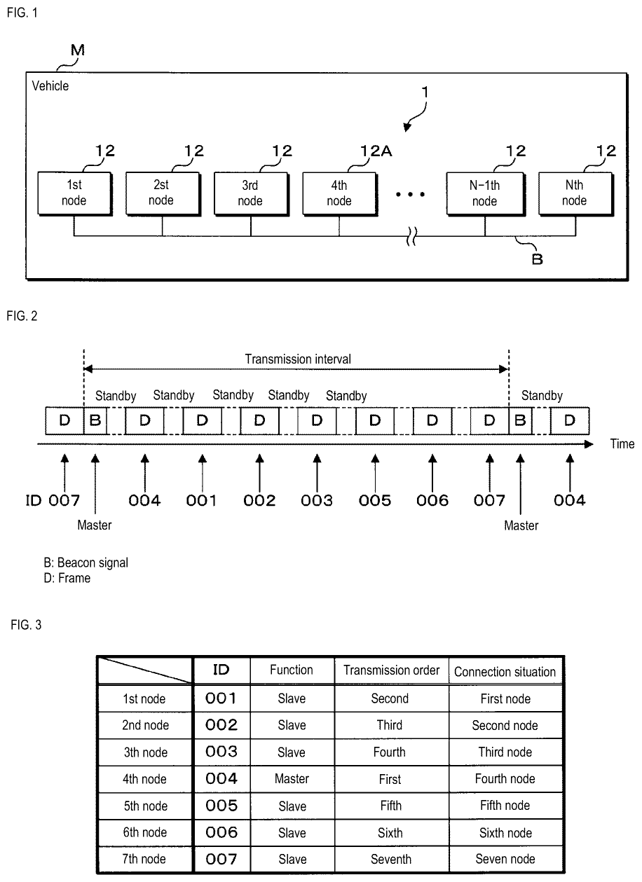

FIG. 1 is a block diagram showing the main configuration of a communication system 1 in the present embodiment. The communication system 1 is installed in a vehicle M using Ethernet, for example. The communication system 1 has N number of nodes (in-vehicle devices), and the N nodes are connected to a communication bus B. N is an integer of 3 or more and is the number of nodes provided in the communication system 1. The N nodes are connected to the communication bus B by a so-called daisy chain method, that is, by being linked together.

The N nodes include one node 12A and (N−1) nodes 12. The node 12A is, for example, an ECU (Electronic Control Unit) or a relay device, and the nodes 12 are, for example, ECUs, sensors, actuators, and the like.

The node 12A and (N−1) nodes 12 each transmit a data frame including specific data as main data via the communication bus B, for example. The data frames indicate a transmission destination.

The node 12A detects the occurrence of disconnection in the communication system 1. Detection of disconnection of the communication system 1 is performed based on whether a data frame or a dummy frame described later of the node 12A or a node 12 is received. Hereinafter, data frames and dummy frames will also be referred to simply as frames.

When a frame could not be received from a predetermined node 12, the node 12A generates unreceived node information indicating that a frame could not be received from the predetermined node 12 or changes the generated unreceived node information.

In the communication system 1, when one of the node 12A and (N-1) nodes 12 transmits a frame, all nodes other than the one node receive the frame. The node 12A and (N-1) nodes 12, having received a frame, each discard the received frame when the destination of the frame is not the respective node.

Hereinafter, for convenience of description, the case where N is “7”, that is, the communication system 1 is constituted by one node 12A and six nodes 12, will be described as an example.

That is, in the communication system 1, the node 12A and the six nodes 12 are connected to the communication bus B by a daisy chain method, with the end nodes on both end sides respectively being the 1st node and the 7th node, and the drop nodes being the 2nd to 6th nodes. Specifically, as shown in FIG. 1, in the communication system 1, the 2nd to 6th nodes 12 are connected to the communication bus B in the stated order between the 1st node 12, which is one end node, and the 7th node 12, which is the other end node. Hereinafter, the node 12A and the six nodes 12 will also be referred to as the 1st to 7th nodes 12 and 12A.

FIG. 2 is a diagram for describing a method for transmitting frames in the communication system 1.

In the communication system 1, the node 12A and the six nodes 12 each transmit frames in accordance with the PLCA (Physical Layer Collision Avoidance) method, for example. As shown in FIG. 2, a beacon signal is repeatedly transmitted via the communication bus B. When the beacon signal is transmitted, frames are transmitted from the 1st to 7th nodes 12 and 12A via the communication bus B. The beacon signal indicates the start of frame transmission. The beacon signal is transmitted by a node that functions as a master in the communication system 1. In the communication system 1, the node 12A functions as the master, and the six nodes 12 functions as slaves.

When the node 12A transmits the beacon signal, the node 12A and the six nodes 12 transmit frames in accordance with an order determined in advance. FIG. 3 is an order table showing the transmission order of frames in the communication system 1. In addition to the order of frame transmission, the table of FIG. 3 shows the ID, function, and connection situation of the node 12A and the six nodes 12. The connection situation is, for example, information indicating the order in which the node 12A and the six nodes 12 are connected to the communication bus B.

As shown in FIG. 3, the 1st to 7th nodes 12 and 12A are each assigned an ID in advance. In the example in FIG. 3, the numbers 001 to 007 are sequentially assigned as IDs to the 1st to 7th nodes 12 and 12A, respectively. In the example in FIG. 3, the order of transmission of each of the 1st to 7th nodes 12 and 12A is set such that the 4th node 12A is first in transmission order, the 1st to 3rd nodes 12 are second to fourth in transmission order, and the 5th to 7th nodes 12 are fifth to seventh in transmission order. That is, the master is first in transmission order. Also, with regard to the connection situation, as described above, the 1st to 7th nodes 12 and 12A sequentially correspond to the first to seventh nodes in connection order, with the 1st node 12 which is an end node as the first node in connection order.

As shown in FIG. 2, when the node 12A has transmitted the beacon signal, first, the 4th node 12A whose ID is 004 transmits a frame. Next, the 1st to 3rd nodes 12 whose IDs are 001 to 003 each transmit a frame in the stated order. Henceforth, the 5th to 7th nodes 12 whose IDs are 005 to 007 each transmit a frame in the stated order. The 4th node 12A transmits the beacon signal again when the 7th node 12 whose ID is 007 ends frame transmission.

The 4th node 12A, after ending transmission of the beacon signal, waits until a preset standby period elapses, and transmits a frame when the standby period had elapsed. The 1st to 3rd nodes 12 and 5th to 7th nodes 12 each wait for the standby period to elapse from when transmission of the frame of the node 12 immediately previous in order ends and transmit a frame when the standby period elapses.

As described above, for example, with the PLCA method, collision of data is avoided, by the 4th node 12A that functions as the master and the 1st to 3rd nodes 12 and 5th to 7th nodes 12 that function as slaves using the beacon signal to synchronize.

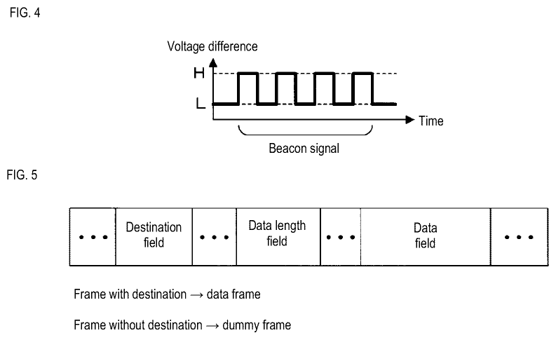

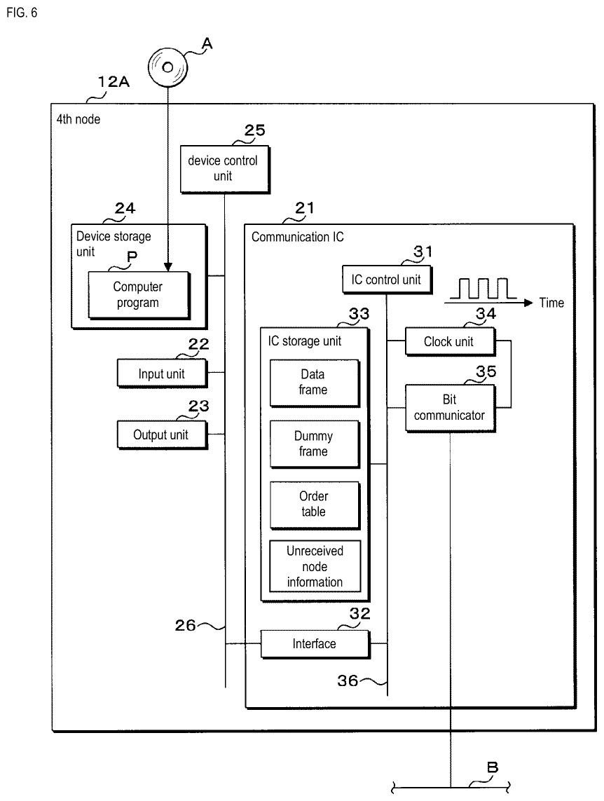

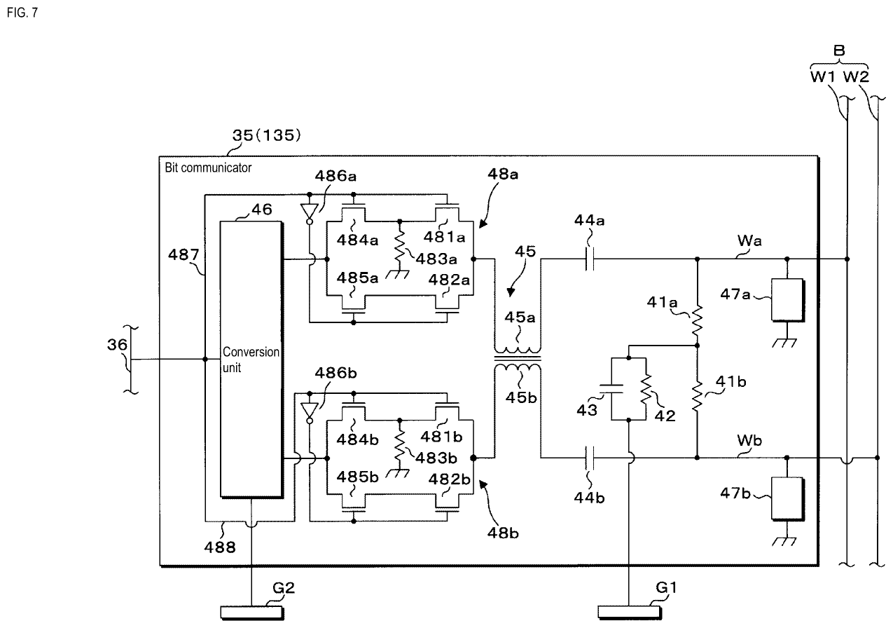

FIG. 4 is a waveform diagram showing an example of a waveform of the beacon signal. The vertical axis and horizontal axis in FIG. 4 respectively show voltage difference and time. The communication bus B includes a first lead wire W1 and a second lead wire W2 (see FIG. 7). The first lead wire W1 and the second lead wire W2 are twisted to realize a twisted pair wire. The beacon signal is constituted by a plurality of bits, and the waveform of the beacon signal is determined in advance. The 4th node 12A transmits the beacon signal each time a 1-bit period elapses, by adjusting the voltage difference between the first lead wire W1 and the second lead wire W2 included in the communication bus B to a high-level voltage or a low-level voltage. In FIG. 4, the high-level voltage and the low-level voltage are respectively shown by H and L.

Each of the 1st to 7th nodes 12 and 12A transmits a frame, by adjusting the voltage difference between the first lead wire W1 and the second lead wire W2 included in the communication bus B to a high-level voltage or a low-level voltage each time a 1-bit period elapses.

With each bit, a high-level voltage or a low-level voltage is indicated. In the example in FIG. 4, the beacon signal is constituted by 7 bits. The beacon signal is output alternately at the high-level voltage and the low-level voltage. Note that the number of bits constituting the beacon signal is not limited to 7 bits.

When the 4th node 12A transmits the beacon signal via the communication bus B, the 1st to 3rd nodes 12 and 5th to 7th nodes 12 receive the beacon signal. In the 1st to 3rd nodes 12 and 5th to 7th nodes 12, a clock signal constituted by a high-level voltage and a low-level voltage is output. With the clock signal, the voltage rises or falls cyclically. The rise of the voltage is a changeover from the low-level voltage to the high-level voltage, and the fall of the voltage is a changeover from the high-level voltage to the low-level voltage.

The 1st to 3rd nodes 12 and 5th to 7th nodes 12, on receiving the beacon signal, adjust the time of the rise or fall of the clock signal. The 1st to 3rd nodes 12 and 5th to 7th nodes 12 align the time of the rise or fall with the end time of the beacon signal, for example. In a configuration in which processing is executed at the time of the rise of the clock signal, the time of the rise of the clock signal is adjusted. In a configuration in which processing is performed at the time of the fall of the clock signal, the time of the fall of the clock signal is adjusted.

In this way, by adjusting the time of the rise or fall of the clock signal, synchronization between the 4th node 12A and the 1st to 3rd nodes 12 and 5th to 7th nodes 12 is realized.

FIG. 5 is a diagram for describing the contents of the frame transmitted by the 1st to 7th nodes 12 and 12A. The frame includes a destination field, a data length field, and a data field. The frame is constituted by a plurality of bits. The bit values 1 and zero respectively corresponds to the high-level voltage and the low-level voltage, for example.

The destination field of the frame indicates where the frame is to be transmitted. An ID, for example, is shown in the destination field. The data field of the frame contains the main data. The data length field of the frame indicates the length of the main data. The unit of length of the main data is a bit.

In the frame, the number of bits constituting portions other than the data field is fixed. The number of bits constituting the main data is variable, and the length of the frame is determined once the length of the main data is determined.

In the present embodiment, the destination of the 1st to 7th nodes 12 and 12A is a node other than the transmission source among the nodes connected to the communication bus B. For example, the destination of the frame transmitted by the 4th node 12A is at least one of the 1st to 3rd nodes 12 and 5th to 7th nodes 12. The destination of the frame transmitted by the 1st node 12 is at least one of the 4th node 12A, the 2nd and 3rd nodes 12, and the 5th to 7th nodes 12.

The 1st to 7th nodes 12 and 12A each, furthermore, transmit a dummy frame whose destination is not the 1st to 7th nodes 12 and 12A.

In the case where seven IDs are assigned, as shown in FIG. 3, the destination of the dummy frame is not any of the 1st to 7th nodes 12 and 12A corresponding to 001 to 007. The destination of the dummy frame is a node whose ID is 999, for example. That is, the destination of the dummy frame does not exist among the nodes connected to the communication bus B.

As aforementioned, the 1st to 7th nodes 12 and 12A, in the case of having received a frame, each discard the received frame when the destination of the frame is different from the respective node. Accordingly, when a dummy frame is transmitted, the 1st to 7th nodes 12 and 12A all discard the received dummy frame.

FIG. 6 is a block diagram showing the main configuration of the 4th node 12A of the communication system 1. The 4th node 12A has a communication IC 21 (communication unit), an input unit 22, an output unit 23, a device storage unit 24, and a device control unit 25. The communication IC 21, the input unit 22, the output unit 23, the device storage unit 24, and the device control unit 25 are connected to a device bus 26. The communication IC 21 is connected to the communication bus B, and, for example, a sensor is connected to the input unit 22, and an electrical device is connected to the output unit 23. IC is an abbreviation for Integrated Circuit.

When a detection value of the sensor is input to the input unit 22, for example, the device control unit 25 generates a data frame that includes the detection value of the sensor as the main data and provides the generated data frame to the communication IC 21. The communication IC 21 transmits the provided data frame via the communication bus B.

The communication IC 21 receives frames transmitted via the communication bus B, and, when the destination of a received frame is not the 4th node 12A, discards the received frame. Accordingly, when a dummy frame is received, the communication IC 21 discards the received dummy frame.

When, in the case where a data frame is received, the destination of the received data frame is the 4th node 12A, the communication IC 21 provides the received data frame to the device control unit 25.

The communication IC 21 detects disconnection in the communication system 1. If disconnection is detected in the communication system 1, the communication IC 21, having specified the disconnection location, selects one node 12 from the 1st to 3rd nodes 12 and 5th to 7th nodes 12 based on the specified disconnection location, and transmits a resistance value adjustment instruction to the selected node 12.

The device storage unit 24 is, for example, a non-volatile memory. The device storage unit 24 stores a computer program P. A processing element of the device control unit 25 executes data frame generation processing by executing the computer program P. The device control unit 25 generates a data frame and provides the generated data frame to the communication IC 21.

Note that the computer program P may be provided to the 4th node 12A, using a non-transitory storage medium A on which the computer program P is recorded in a readable manner. The storage medium A is, for example, a portable memory. Examples of portable memory include a CD-ROM, a USB (Universal Serial Bus) memory, an SD card, a Micro SD card, or CompactFlash (registered trademark). In the case where the storage medium A is a portable memory, the processing element of the device control unit 25 may read the computer program P from the storage medium A using a reading device not shown. The read computer program P is stored in the device storage unit 24. Furthermore, the computer program P may be provided to the 4th node 12A, by a communication unit not shown of the 4th node 12A communicating with an external device. In this case, the processing element of the device control unit 25 acquires the computer program P through the communication unit. The acquired computer program P is stored in the device storage unit 24.

In the communication IC 21, an IC control unit 31, an interface 32, an IC storage unit 33, a clock unit 34, and a bit communicator 35 are connected to an IC bus 36. The interface 32 is connected to the device bus 26, and the bit communicator 35 is connected to the communication bus B.

The IC storage unit 33 is, for example, a non-volatile memory. The data frame from the device control unit 25 is provided to the IC control unit 31 via the interface 32. The IC control unit 31 writes the provided data frame to the IC storage unit 33. Also, the IC storage unit 33 stores a dummy frame, unreceived node information, and the like in advance. Furthermore, the IC storage unit 33 stores the value of an integer K that is used in disconnection detection processing described later.

Furthermore, the IC control unit 31 performs disconnection detection of the communication system 1. If a frame is not received from any of the nodes 12 (1st to 3rd nodes 12 and 5th to 7th nodes 12), when executing disconnection detection of the communication system 1, the IC control unit 31 generates unreceived node information indicating that fact and writes the unreceived node information to the IC storage unit 33 or updates written unreceived node information.

The clock unit 34 outputs the clock signal to the bit communicator 35. Based on the clock signal, the IC control unit 31 provides the data frame or dummy frame stored in the IC storage unit 33 to the bit communicator 35 one bit at a time and provides the beacon signal to the bit communicator 35 one bit at a time.

For example, the bit communicator 35 transmits a 1-bit signal or 1-bit data provided by the IC control unit 31, each time the clock signal rises. The bit communicator 35 transmits the 1-bit signal or 1-bit data by adjusting the voltage difference between the first lead wire W1 and the second lead wire W2 included in the communication bus B to a high-level voltage or a low-level voltage. The voltage difference is maintained at the high-level voltage or the low-level voltage for one period of the clock signal. The period of the clock signal corresponds to a 1-bit period.

Also, the bit communicator 35 receives a 1-bit signal or 1-bit data by detecting the voltage difference between the first lead wire W1 and the second lead wire W2 included in the communication bus B, each time the clock signal rises. The bit communicator 35 notifies the received 1-bit signal or data to the IC control unit 31.

Note that the bit communicator 35 may transmit 1-bit data provided by the IC control unit 31, each time the clock signal falls. Also, the bit communicator 35 may receive a 1-bit signal or 1-bit data, by detecting the voltage difference of the communication bus B, each time the clock signal falls.

As described above, when, in the case where the bit communicator 35 receives a frame, the destination of the received frame is not the 4th node 12A, the IC control unit 31 discards the received frame. Accordingly, when the bit communicator 35 receives a dummy frame, the IC control unit 31 discards the received dummy frame. When, in the case where the bit communicator 35 receives a frame (data frame), the destination of the received frame is the 4th node 12A, the IC control unit 31 provides the received data frame to the device control unit 25 via the interface 32.

The IC storage unit 33 stores a computer program (not shown). The IC control unit 31, by executing the computer program, executes processing such as writing, transmission, reception, and disconnection detection in parallel.

In the writing processing, the IC control unit 31, as aforementioned, writes a data frame to the IC storage unit 33. In the transmission processing, the IC control unit 31 controls the bit communicator 35 to transmit the beacon signal, and, after controlling the bit communicator 35 to transmit the beacon signal, controls the bit communicator 35 to transmit a data frame or a dummy frame. In the reception processing, the IC control unit 31, as aforementioned, executes processing relating to frames received by the bit communicator 35. In the disconnection detection processing, the IC control unit 31 detects whether disconnection has occurred in the communication system 1 and specifies the disconnection location.

Also, the IC storage unit 33 stores an order table (see FIG. 3) indicating the order in which the 1st to 7th nodes 12 and 12A perform transmission.

FIG. 7 is a circuit diagram of the bit communicator 35 of the 4th node 12A in the communication system 1. The configuration of the bit communicator 35 conforms to 10BASE-T1S of IEEE 802.3cg (IEEE is a registered trademark). Accordingly, the bit communicator 35 is configured to realize transmission of a baseband signal having a data rate of 10 Mbps. Here, the baseband signal is transmitted via a twisted pair wire constituted by the first lead wire W1 and the second lead wire W2.

The bit communicator 35 includes two electrostatic suppressors 47a and 47b, three resistors 41a, 41b, and 42, three capacitors 43, 44a, and 44b, a common mode choke coil 45, variable termination circuits 48a and 48b (second termination circuit), and a conversion unit 46. The common mode choke coil 45 includes a first inductor 45a, a second inductor 45b, and an annular magnetic body. The first inductor 45a and the second inductor 45b are both wrapped around the magnetic body. The resistance values of resistors 41 a and 41 b are, for example, 1/100 of the resistor 42.

The conversion unit 46 is connected to the first lead wire W1 of the communication bus B by a device lead wire Wa and is connected to the second lead wire W2 of the communication bus B by a device lead wire Wb. The conversion unit 46 is, furthermore, connected to the IC bus 36.

The electrostatic suppressor 47a, the capacitor 44a, the first inductor 45a, and the variable termination circuit 48a are disposed on the device lead wire Wa. The electrostatic suppressor 47a and the capacitor 44a are disposed on the first lead wire W1 side of the first inductor 45a. Similarly, the electrostatic suppressor 47b, the capacitor 44b, the second inductor 45b, and the variable termination circuit 48b are disposed on the device lead wire Wb. The electrostatic suppressor 47b and the capacitor 44b are disposed on the second lead wire W2 side of the second inductor 45b.

One end of the electrostatic suppressor 47a is connected to the first lead wire W1 side of the capacitor 44a, and the other end of the electrostatic suppressor 47a is connected to GND. One end of the resistor 41a is connected to the device lead wire Wa, between the capacitor 44a and the electrostatic suppressor 47a. Similarly, one end of the static suppressor 47b is connected to the second lead wire W2 side of the capacitor 44b, and the other end of the static suppressor 47b is connected to GND. One end of the resistor 41b is connected to the device lead wire Wb, between the capacitor 44b and the electrostatic suppressor 47b. The other end of the resistor 41a is connected to the other end of the resistor 41b. The connection node between the resistors 41a and 41b is connected to one end of the resistor 42 and the capacitor 43. The other end of the resistor 42 and the capacitor 43 is connected to a first conductor G1. The first conductor G1 is disposed within the 4th node 12A.

The electrostatic suppressors 47a and 47b suppress noise caused by so-called ESD (electrostatic discharge).

The resistors 41a, 41b, and 42 and capacitor 43 function as a termination circuit (hereinafter, referred to as the first termination circuit) and suppress reflection of a signal represented by the voltage difference between the first lead wire W1 and the second lead wire W2.

The two capacitors 44a and 44b respectively remove the DC component from the two voltages input from the two device lead wires Wa and Wb and output the two voltages from which the DC component is removed to the common mode choke coil 45.

The common mode choke coil 45 removes common mode noise from the two voltages output by the capacitors 44a and 44b, and outputs the two voltages obtained by removing the common mode noise to the conversion unit 46 via the variable termination circuits 48a and 48b.

The variable termination circuits 48a and 48b suppress reflection of the signal represented by the voltage difference between the first lead wire W1 and the second lead wire W2, similarly to the first termination circuit constituted by the resistors 41a, 41b, and 42 and capacitor 43. Whereas the termination resistance of the first termination circuit is constant, the variable termination circuits 48a and 48b are configured to be able to adjust the termination resistance.

The variable termination circuits 48a and 48b are provided between the common mode choke coil 45 and the conversion unit 46. The variable termination circuit 48a includes four oxide MOSFETs 481a, 482a, 484a, and 485a, a resistor 483a, and an inverter 486 a. The resistor 483 a need only be 45 to 55 Ω, and is desirably 50 Ω. The variable termination circuit 48b includes four oxide MOSFETs 481b, 482b, 484b, and 485b, a resistor 483b, and an inverter 486b. The resistor 483b need only be 45 to 55 Ω, and is desirably 50 Ω.

The device lead wire Wa is branched between the common mode choke coil 45 and the conversion unit 46, and the MOSFETs 481a and 484a are connected to one branch thereof. The MOSFET 481a is provided closer to the common mode choke coil 45 than is the MOSFET 484a. One end of the resistor 483a is connected between the MOSFETs 481a and 484a, and the other end of the resistor 483a is connected to GND. The drain terminal of the MOSFET 481a is connected to the common mode choke coil 45, and the source terminal is connected to one end of the resistor 483a. The drain terminal of the MOSFET 484a is connected to the conversion unit 46, and the source terminal is connected to one end of the resistor 483a. The gate terminals of the MOSFETs 481a and 484a are connected to the IC bus 36 via a device lead wire 487.

The MOSFETs 482a and 485a are connected to the other branch, with the MOSFET 482a being provided closer to the common mode choke coil 45 than is the MOSFET 485a. The drain terminal of the MOSFET 482a is connected to the common mode choke coil 45, the source terminal is connected to the source terminal of the MOSFET 485a, and the drain terminal of the MOSFET 485a is connected to the conversion unit 46. The gate terminals of the MOSFETs 482a and 485a are connected to the device lead wire 487 via the inverter 486a.

The device lead wire Wb is branched between the common mode choke coil 45 and the conversion unit 46, and the MOSFETs 481b and 484b are connected to one branch thereof. The MOSFET 481b is provided closer to the common mode choke coil 45 than is the MOSFET 484b. One end of the resistor 483b is connected between the MOSFETs 481b and 484b, and the other end of the resistor 483b is connected to GND. The drain terminal of the MOSFET 481b is connected to the common mode choke coil 45, and the source terminal is connected to one end of the resistor 483b. The drain terminal of the MOSFET 484b is connected to the conversion unit 46, and the source terminal is connected to one end of the resistor 483b. The gate terminals of the MOSFETs 481b and 484b are connected to the IC bus 36 via a device lead wire 488.

The MOSFETs 482b and 485b are connected to the other branch, with the MOSFET 482b being provided closer to the common mode choke coil 45 than is the MOSFET 485b. The drain terminal of the MOSFET 482b is connected to the common mode choke coil 45, the source terminal is connected to the source terminal of the MOSFET 485b, and the drain terminal of the MOSFET 485b is connected to the conversion unit 46. The gate terminals of the MOSFETs 482b and 485b are connected to the device lead wire 488 via the inverter 486b.

For example, when a high-level voltage is input from the IC control unit 31 to the variable termination circuit 48a via the IC bus 36 and the device lead wire 487, the high-level voltage is input to the gates of the MOSFETs 481a and 484a and thus the MOSFETs 481a and 484a turn on, and a low-level voltage inverted by the inverter 486a is input to the MOSFETs 482a and 485a and thus the MOSFETs 482a and 485a turn off. At this time, the termination resistance value of the variable termination circuit 48a will be the resistance value of the resistor 483a.

When a low-level voltage is input from the IC control unit 31 to the variable termination circuit 48a, the low-level voltage is input to the gates of the MOSFETs 481a and 484a and thus the MOSFETs 481a and 484a turn off, and an inverted high-level voltage is input to the MOSFETs 482a and 485a and thus the MOSFETs 482a and 485a turn on. At this time, the termination resistance value of the variable termination circuit 48a is “0 Ω”.

Note that this similarly applies to the variable termination circuit 48b, and a detailed description thereof is omitted.

In this way, the termination resistance value of the bit communicator 35 can be adjusted, by adjusting the termination resistance values of the variable termination circuits 48a and 48b.

The conversion unit 46 detects the voltage difference between the two voltages input from the common mode choke coil 45 via the variable termination circuits 48a and 48b, each time the clock signal input from the clock unit 34 rises or falls. When the voltage difference is detected, the conversion unit 46 outputs a bit value corresponding to the detected voltage difference to the IC control unit 31. The bit value is zero or 1. The bit value is represented by a voltage whose reference potential is the potential of a second conductor G2. The bit values 1 and zero respectively correspond to, for example, a high-level voltage and a low-level voltage whose reference potential is the potential of the second conductor G2. The second conductor G2 is disposed within the 4th node 12A and is different from the first conductor G1.

As aforementioned, the bit communicator 35 transmits a signal or data one bit at a time. The IC control unit 31 provides a 1-bit signal or 1-bit data to the conversion unit 46. Each time the clock signal input from the clock unit 34 rises or falls, the conversion unit 46 adjusts the voltage difference between the two device lead wires Wa and Wb to a voltage corresponding to the 1-bit signal or data provided by the IC control unit 31.

The two voltages output by the conversion unit 46 are input to the common mode choke coil 45 via the variable termination circuits 48a and 48b. The common mode choke coil 45 removes common mode noise from the two voltages output by the conversion unit 46 and outputs the resultant voltages to the two capacitors 44a and 44b. The two capacitors 44a and 44b remove the DC component from the two voltages input from the common mode choke coil 45 and output the resultant voltages to the two electrostatic suppressors 47a and 47b. The two electrostatic suppressors 47a and 47b reduce noise caused by electrostatic discharge from the two voltages input from the two capacitors 44a and 44b and apply the resultant voltages to the first lead wires W1 and the second lead wire W2 of the communication bus B. The voltage difference between the first lead wire W1 and the second lead wire W2 is thereby adjusted to a high-level voltage or a low-level voltage.

The 1st to 3rd nodes 12 and 5th to 7th nodes 12 have the same configuration, and, hereinafter, only the configuration of the 2nd node 12 will be described, and description of the configuration of the other nodes 12 will be omitted.

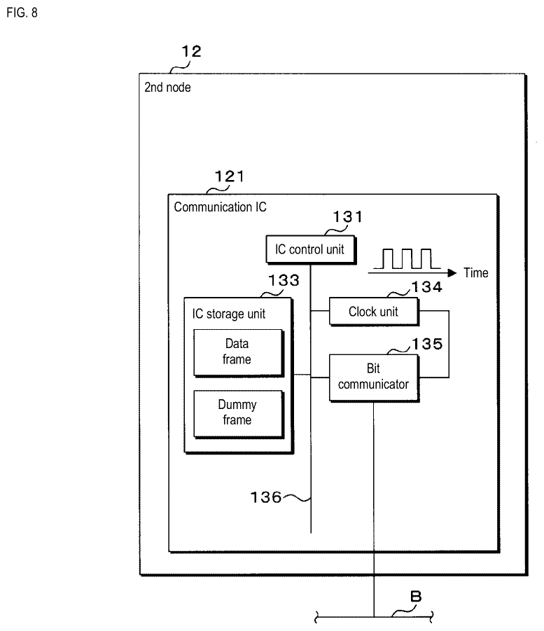

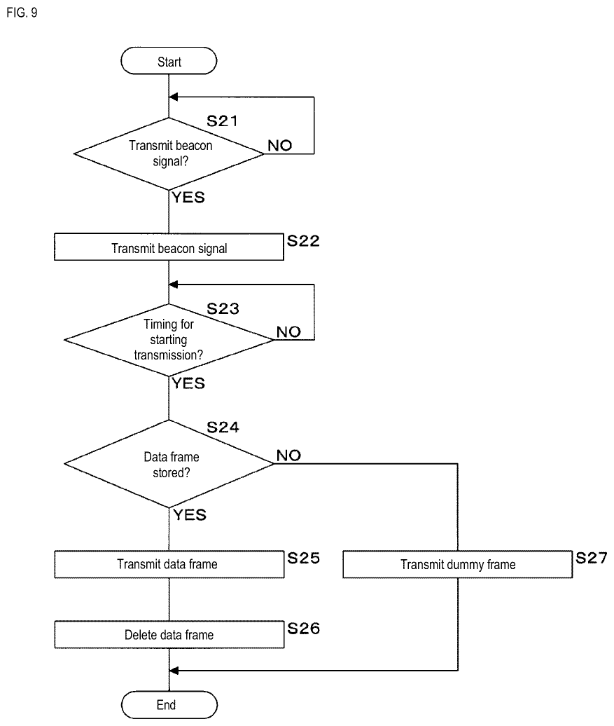

FIG. 8 is a block diagram showing the main configuration of the 2nd node 12 of the communication system 1. The 2nd node 12 has a communication IC 121 (communication unit) connected to the communication bus B. The communication IC 121 includes an IC control unit 131, an IC storage unit 133, a clock unit 134, and a bit communicator 135, similarly to the communication IC 21 of the 4th node 12A. The IC control unit 131, the IC storage unit 133, the clock unit 134, and the bit communicator 135 are connected to an IC bus 136.

The IC storage unit 133, the clock unit 134, and the bit communicator 135 of the 2nd node 12 are similar to the IC storage unit 33, the clock unit 34, and the bit communicator 35 of the 4th node 12A. In particular, the values of the resistors and capacitor constituting the termination circuit (first termination circuit) in the bit communicator 135 are the same as the values of the resistors 41a, 41b, and 42 and capacitor 43 of the bit communicator 35.

When, in the case where the bit communicator 135 receives a frame, the destination of the received frame is not the 2nd node 12, the IC control unit 131 discards the received frame. Accordingly, when the bit communicator 135 receives a dummy frame, the IC control unit 131 discards the received dummy frame. When, in the case where the bit communicator 135 receives a frame (data frame), the destination of the received frame is the 2nd node 12 (node of the bit communicator 135), the IC control unit 131 determines whether a resistance value adjustment instruction is included in the main data of the data frame.

In the 2nd node 12, the IC control unit 131 does not provide a beacon signal to the bit communicator 135. The bit communicator 135 of the 2nd node 12 only receives the beacon signal. The IC control unit 131, upon receiving the beacon signal, adjusts the time of the rise or fall of the clock signal, based on the received beacon signal, as described above. In a configuration in which processing is performed at the time of the rise of the clock signal, the time of the rise of the clock signal is adjusted. In a configuration in which processing is performed at the time of the fall of the clock signal, the time of the fall of the clock signal is adjusted.

The IC control unit 131 executes writing processing and transmission processing, similarly to the IC control unit 31 of the 4th node 12A. In the transmission processing of the 2nd node 12, however, the IC control unit 131 adjusts the clock signal based on the beacon signal received by the bit communicator 135, and thereafter controls the bit communicator 135 to transmit a data frame or a dummy frame.

Also, the IC control unit 131 executes processing relating to data frames received by the bit communicator 135. For example, when it is determined that the main data of a received data frame includes a resistance value adjustment instruction, the IC control unit 131 adjusts the termination resistance value of the terminal circuit of the bit communicator 135.

Hereinafter, a detailed description will be given using FIG. 7.

When the main data of the received data frame includes a resistance value adjustment instruction, the IC control unit 131 outputs a high-level voltage, for example, to the variable termination circuits 48a and 48b of the bit communicator 135, via the IC bus 136. At this time, the high-level voltage is input to the gates of the MOSFETs 481a, 484a, 481b, and 484b of the bit communicator 135 and thus the MOSFETs 481a, 484a, 481b, and 484b turn on. Also, an inverted low-level voltage is input to the MOSFETs 482a, 485a, 482b, and 485b of the bit communicator 135 and thus the MOSFETs 482a, 485a, 482b, and 485b turn off. Therefore, the termination resistance values of the variable termination circuits 48a and 48b of the bit communicator 135 will respectively be the resistance values of the resistors 483a and 483b. The termination resistance value of the bit communicator 135 at this time (hereinafter, referred to as the change resistance value) is affected by the termination resistance values of the variable termination circuits 48a and 48b of the bit communicator 135.

On the other hand, when a data frame that includes a resistance value adjustment instruction is not received, the IC control unit 131 outputs a low-level voltage to the variable termination circuits 48a and 48b of the bit communicator 135, via the IC bus 136. At this time, the low-level voltage is input to the gates of the MOSFETs 481a, 484a, 481b, and 484b of the bit communicator 135 and thus the MOSFETs 481a, 484a, 481b, and 484b turn off. Also, a high-level voltage is input to the MOSFETs 482a, 485a, 482b, and 485b of the bit communicator 135 and thus the MOSFETs 482a, 485a, 482b, and 485b turn on. Therefore, the termination resistance values of the variable termination circuits 48a and 48b of the bit communicator 135 are both “0 Ω”. The termination resistance value of the bit communicator 135 at this time (hereinafter, referred to as the normal resistance value) is affected by the termination resistance value of the first termination circuit of the bit communicator 135.

In the 4th node 12A, when the detection value of the sensor is input to the input unit 22 or when disconnection of the communication system 1 is detected, the data frame generation processing described above is executed. In this case, the device control unit 25 generates a data frame, with the detection value of the sensor input to the input unit 22 or a resistance value adjustment instruction as the main data of the data frame.

Next, the device control unit 25 provides the generated data frame to the IC control unit 31 via the interface 32. At this time, the IC control unit 31 performs writing processing for writing the data frame provided by the device control unit 25 to the IC storage unit 33. The data frame stored in the IC storage unit 33 is transmitted via the communication bus B.

FIG. 9 is a flowchart showing the procedure of transmission processing by the IC control unit 31 of the 4th node 12A. Hereinafter, the transmission processing by the IC control unit 31 will be described, based on FIG. 9.

First, the IC control unit 31 of the 4th node 12A determines whether to transmit a beacon signal (step S21). If the node 12 that is last in order starts transmission of a frame after the standby period elapses, the time at which this node 12 ends transmission of the frame is the timing at which the beacon signal is transmitted. If the node 12 that is last in order does not start transmission of a frame after the standby period elapses, the time at which the standby period elapses is the timing at which the beacon signal is transmitted.

If it is determined to not transmit the beacon signal (step S21: NO), the IC control unit 31 executes step S21 again and waits until the timing for transmitting the beacon signal arrives. If it is determined to transmit the beacon signal (step S21: YES), the IC control unit 31 instructs the bit communicator 35 to transmit the beacon signal via the communication bus B (step S22). As aforementioned, in the nodes 12 (1st to 3rd nodes 12 and 5th to 7th nodes 12), when the bit communicator 135 receives the beacon signal, the IC control unit 131 adjusts the clock signal.

After executing step S22, the IC control unit 31 determines whether it is the timing for starting transmission of a frame (step S23). The 4th node 12A functions as the master and is first in transmission order. In step S23, the IC control unit 31 determines whether the standby period has elapsed from when transmission of the beacon signal ended. The timing at which the standby period elapses is the timing for starting transmission. The IC control unit 31 is able to ascertain the timing for ending transmission of a frame, based on the data length indicated in the data length field of the frame.

If it is determined that it is not the timing for starting transmission of a frame (step S23: NO), the IC control unit 31 executes step S23 again and waits until the timing for starting transmission arrives.

If it is determined that it is the timing for starting transmission of a frame (step S23: YES), the IC control unit 31 determines whether a data frame is stored in the IC storage unit 33 (step S24). If it is determined that a data frame is stored in the IC storage unit 33 (step S24: YES), the IC control unit 31 instructs the bit communicator 35 to transmit the data frame stored in the IC storage unit 33 one bit at a time via the communication bus B (step S25). After executing the processing of step S25, the IC control unit 31 deletes the transmitted data frame from the IC storage unit 33 (step S26).

If it is determined that a data frame is not stored in the IC storage unit 33 (step S24: NO), the IC control unit 31 instructs the bit communicator 35 to transmit the dummy frame stored in the IC storage unit 33 one bit at a time (step S27). The IC control unit 31 ends the transmission processing after executing the processing of step S26 or step S27. Such transmission processing is performed repeatedly.

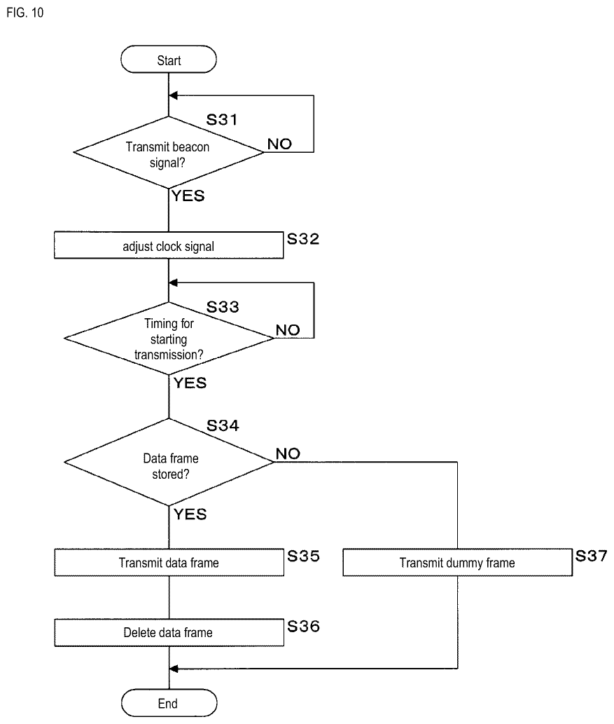

FIG. 10 is a flowchart showing the procedure of transmission processing by the IC control unit 131 of each of the 1st to 3rd nodes 12 and 5th to 7th nodes 12. Hereinafter, the transmission processing by the IC control unit 131 will be described, based on FIG. 10.

First, the IC control unit 131 of each of the 1st to 3rd nodes 12 and 5th to 7th nodes 12 determines whether the bit communicator 135 has received the beacon signal (step S31). If it is determined that the bit communicator 135 has not received the beacon signal (step S31: NO), the IC control unit 131 executes step S31 again and waits until the bit communicator 135 receives the beacon signal.

If it is determined that the bit communicator 135 has received the beacon signal (step S31: YES), the IC control unit 131 adjusts the clock signal output by the clock unit 134 based on the received beacon signal (step S32). In step S32, the IC control unit 131 adjusts the time of the rise or fall of the clock signal as aforementioned. After executing the processing of step S32, the IC control unit 131 determines whether it is the timing for starting transmission of a frame (step S33).

As described above, the order of transmission of the 1st to 7th nodes 12 and 12A is assigned in advance. If the node immediately previous to the current node in the order in the order table (see FIG. 3) started transmission of a frame, the time at which the standby period elapses from when the immediately previous node ends transmission of the frame is the timing for starting transmission. If the immediately previous node in the order did not start transmission of a frame, the time at which the standby period elapses from that time is the timing for starting transmission of a frame.

With respect to the 2nd node 12 whose ID is 002, the node immediately previous in order is the 1st node 12 whose ID is 001. In relation to the 3rd node 12 whose ID is 003, the immediately previous node in the order is the 2nd node 12 whose ID is 002.

The IC control unit 131 is able to ascertain the timing for ending transmission of a frame, based on the data length indicated in the data length field of the frame.

If it is determined that it is not the timing for starting transmission of a frame (step S33: NO), the IC control unit 131 executes step S33 again and waits until the timing for starting transmission of a frame arrives. If it is determined that it is the timing for starting transmission of a frame (step S33: YES), the IC control unit 131 executes step S34.

The processing of steps S34 to S37 of the transmission processing executed by the IC control unit 131 of each of the 1st to 3rd nodes 12 and 5th to 7th nodes 12 is similar to steps S24 to S27 (see FIG. 9) of the transmission processing executed by the IC control unit 31 of the 4th node 12A (see FIG. 9). Accordingly, description of steps S34 to S37 will be omitted.

The IC control unit 131 executes the processing of step S36 or step S37 and thereafter ends the transmission processing. Such transmission processing is performed repeatedly.

As described above, the respective bit communicators 35 and 135 of the 1st to 7th nodes 12 and 12A transmit a dummy frame when there is no data frame in the IC storage units 33 and 133 to be transmitted to nodes other than the node thereof. Accordingly, the respective bit communicators 35 and 135 of the 1st to 7th nodes 12 and 12A always transmit a data frame or a dummy frame when the transmission order of the node thereof arrives.

As described above, in the communication system 1, the order in which frames are transmitted is determined in advance (see FIG. 3). Also, the beacon signal indicates the start of transmission of a frame performed by the bit communicators 35 and 135 of the 1st to 7th nodes 12 and 12A. Accordingly, the bit communicators 35 and 135 of the 1st to 7th nodes 12 and 12A transmit a data frame or a dummy frame via the communication bus B, in accordance with the predetermined order when the beacon signal is transmitted.

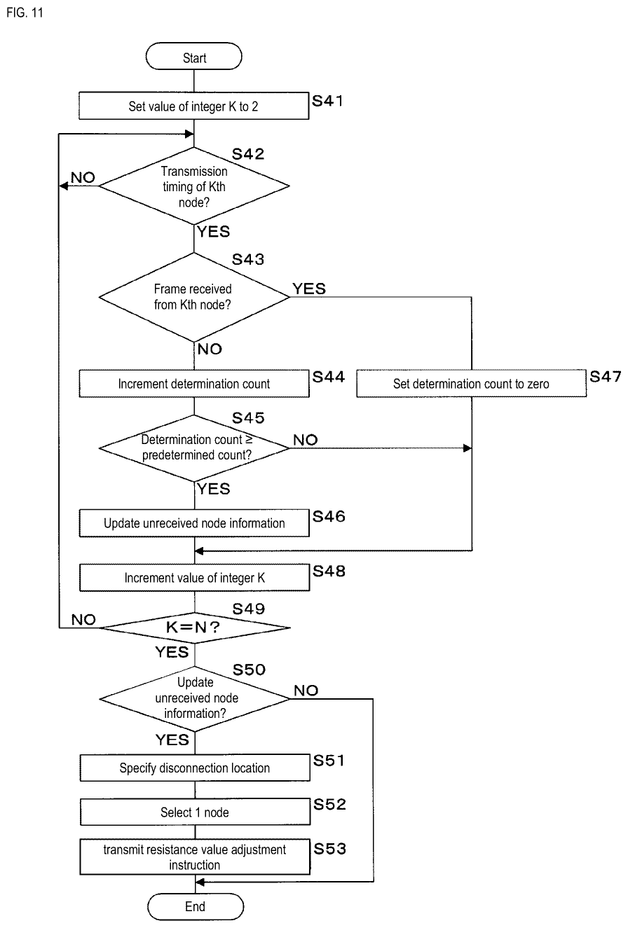

FIG. 11 is a flowchart showing the procedure of disconnection detection processing in the communication system 1. As aforementioned, the disconnection detection processing is executed by the IC control unit 31 of the 4th node 12A. The IC control unit 31 repeatedly executes the disconnection detection processing.

In the disconnection detection processing, the IC control unit 31 of the 4th node 12A determines whether frames have been received in order from the 1st to 3rd nodes 12 and 5th to 7th nodes 12. The number of times it is continuously determined that a frame is not received from any of the nodes 12 (determination count) is stored in the IC storage unit 33. That is, the determination count for each of the nodes 12 (1st to 3rd nodes 12 and 5th to 7th nodes 12) is stored in the IC storage unit 33. At the point in time at which the 4th node 12A is started, all of the determination counts are zero.

After the beacon signal is transmitted, the IC control unit 31 of the 4th node 12A sets the value of the integer K stored in the IC storage unit 33 to 2 (step S41). Next, the IC control unit 31 determines whether it is the transmission timing of the Kth node 12 (step S42). Kth is the order in which frames are transmitted and is indicated in the order table of FIG. 3. The transmission timing is the timing at which a frame is transmitted.

If it is determined that it is not the transmission timing of the Kth node 12 (step S42: NO), the IC control unit 31 executes step S42 again and waits until the transmission timing of the Kth node 12 arrives. If it is determined that it is the transmission timing of the Kth node 12 (step S42: YES), the IC control unit 31 determines whether a frame has been received from the Kth node 12 (step S43).

As aforementioned, a frame transmitted by one node connected to the communication bus B is received by all other nodes connected to the communication bus B. Accordingly, the IC control unit 31 determines that disconnection has occurred in the communication system 1 when the bit communicator 35 does not receive a frame. When the bit communicator 35 receives a frame, the IC control unit 31 determines that disconnection has not occurred in the communication system 1. Disconnection detection of the communication system 1 is thereby possible.

When it is determined that a frame has been received from the Kth node 12 (step S43: YES), the IC control unit 31 changes the determination count of the Kth node 12 to zero (step S47). Thereafter, the processing advances to step S48.

On the other hand, if it is determined that a frame has not been received from the Kth node 12 (step S43: NO), the IC control unit 31 increments the determination count of the Kth node 12 by 1 (step S44). Next, the IC control unit 31 determines whether the determination count of the Kth node 12 is a predetermined count (step S45). The predetermined count is, for example, 2 or more. If it is determined that the determination count of the Kth node 12 is greater than or equal to the predetermined count (step S45: YES), the IC control unit 31 updates the unreceived node information indicating that a frame could not be received from the Kth node 12 (step S46). That is, the IC control unit 31 newly generates unreceived node information indicating that a frame could not be received from the Kth node 12 or adds the Kth node 12 to the nodes 12 from which a frame could not be received.

When it is determined in step S45 that the determination count of the Kth node 12 is less than the predetermined count (step S45: NO), or after executing the processing of one of steps S46 and S47, the IC control unit 31 increments the value of the integer K by 1 (step S48).

Next, the IC control unit 31 determines whether the value of the integer Kis N (step S49). In the present embodiment, N is 7. If it is determined that the value of the integer K is not N (step S49: NO), the IC control unit 31 returns the processing to step S42. The IC control unit 31 determines whether each of the nodes 12 that are second to seventh in transmission order (1st to 3rd nodes 12 and 5th to 7th nodes 12) has transmitted a frame.

If it is determined that the value of the integer K is N (step S49: YES), the IC control unit 31 determines whether the unreceived node information has been updated in the above disconnection detection processing (step S50). If it is determined that the unreceived node information has not been updated (step S50: NO), the IC control unit 31 assumes that disconnection has not occurred in the communication system 1 and ends the processing.

Also, if it is determined that the unreceived node information has been updated (step S50: YES), the IC control unit 31 assumes that disconnection has occurred in the communication system 1 and specifies the disconnection location (step S51). Specification of the disconnection location is performed based on the unreceived node information stored in the IC storage unit 33 and the connection situation (order table).

As described above, the communication system 1 uses a daisy chain method, and thus the nodes are divided into a group consisting of the 1st to 3rd nodes 12 (hereinafter, referred to as the first group) and a group consisting of the 5th to 7th nodes 12 (hereinafter, referred to as the second group) based on the 4th node 12A.

For example, assume that the unreceived node information indicates that a frame could not be received from the Kth node 12, and that the Kth node belongs to the first group. In this case, the IC control unit 31 specifies that disconnection has occurred between the K+1th node 12 and the Kth node 12, given that the node 12 that is closer to the node of the IC control unit 31 (4th node 12A) than is the Kth node 12 is the K+1th node 12, based on the order table. That is, the IC control unit 31 specifies that the disconnection location is between the K+1th node 12 and the Kth node 12.

On the other hand, in the case where the Kth node belongs to the second group, the IC control unit 31 specifies that disconnection has occurred between the K−1th node 12 and the Kth node 12, given that the node 12 that is closer to the node of the IC control unit 31 (4th node 12A) than is the Kth node 12 is the K−1th node 12, based on the order table. That is, the IC control unit 31 specifies that the disconnection location is between the K−1th node 12 and the Kth node 12.

In this way, when the disconnection location is specified, the IC control unit 31 selects one node 12 to serve as an end node, based on the specified disconnection location (step S52). The IC control unit 31 selects the node 12 furthest from the node of the IC control unit 31 (4th node 12A) among the nodes 12 closer to the node of the IC control unit 31 than is the disconnection location.

When disconnection of the communication system 1 is detected, the IC control unit 31 selects the node 12 furthest from the 4th node 12A, among the nodes 12 closer to the 4th node 12A than is the disconnection location in the group in which the disconnection location exists.

For example, when the disconnection location is between the 1st node 12 and the 2nd node 12, the 2nd node 12 which is furthest from the 4th node 12A is selected as the node 12 to serve as an end node, out of the 2nd and 3rd nodes 12 closer to the 4th node 12A than is the disconnection location in the first group in which the disconnection location exists.

The IC control unit 31 transmits a resistance value adjustment instruction to the selected node 12. That is, the IC control unit 31 transmits a data frame that includes a resistance value adjustment instruction as the main data via the communication bus B, with the selected node 12 as the destination (step S53). Thereafter, the processing ends. The IC control unit 31 executes the above disconnection detection processing repeatedly.

As described above, when the disconnection location is between the 1st node 12 and the 2nd node 12, and the 2nd node 12 is selected as the node 12 to serve as an end node, the IC control unit 31 transmits a data frame that includes the resistance value adjustment instruction to the 2nd node 12.

When disconnection has not occurred in the communication system 1, the termination resistance value of the bit communicator 135 of the 2nd node 12 is the normal resistance value and is affected by the termination resistance value of the first termination circuit of the bit communicator 135.

On the other hand, when the bit communicator 135 of the 2nd node 12 receives a data frame and the received data frame includes the resistance value adjustment instruction, the IC control unit 131 of the 2nd node 12 outputs a high-level voltage to the variable termination circuits 48a and 48b via the IC bus 136 in order to set the termination resistance value of the bit communicator 135 to the change resistance value. Description of the operations for setting the termination resistance value of the bit communicator 135 to the change resistance value has already been given and will be omitted here.

Note that when the disconnection location is between the 3rd node 12 and the 4th node 12A, the 4th node 12A is selected as the node 12 to serve as an end node. The 4th node 12A is also selected as the node 12 to serve as an end node, when the disconnection location is between the 5th node 12 and the 4th node 12A. In this case, the IC control unit 31 of the 4th node 12A outputs a high-level voltage to the variable termination circuits 48a and 48b via the IC bus 36 and sets the termination resistance value of the bit communicator 35 to the change resistance value.

In this way, when the termination resistance value of the bit communicator 135 of the 2nd node 12 is the change resistance value, reflection of the signal constituting the data due to disconnection occurring between the 1st node 12 and the 2nd node 12, and generation of noise caused by interference between the nodes 12 and 12A, resulting in normal communication no longer being possible in the communication system 1, can be prevented beforehand. That is, by changing the termination resistance value of the bit communicator 135 of the 2nd node 12 to the change resistance value, noise caused by the reflection of the signal constituting the data can be suppressed, and normal communication between the 2nd to 7th nodes 12 and 12A can be maintained.

In the above, the case where the 1st to 7th nodes 12 and 12A all have the variable termination circuits 48a and 48b is described as an example, but the present disclosure is not limited thereto. For example, a configuration may be adopted in which drop nodes 12 (2nd and 3rd nodes 12 and 5th and 6th nodes 12) excluding the end nodes 12 (1st and 7th nodes 12) have the variable termination circuits 48a and 48b.

In the above, the case where the 4th node 12A is an intermediate position in the connection order of the communication system 1 (daisy chain) is described as an example, but the present disclosure is not limited thereto. It is, however, desirable that the 4th node 12A is an intermediate position in the connection order of the communication system 1.

In the above, the case where the variable termination circuits 48a and 48b are provided outside the conversion unit 46 is described as an example, but the present disclosure is not limited thereto. For example, a configuration may be adopted in which the variable termination circuits 48a and 48b are provided inside a so-called PHY such as the conversion unit 46 to enable switching by register setting or the like.

The embodiments disclosed herein should be considered illustrative in all respects and not restrictive. The scope of the present disclosure is defined by the claims rather than by the foregoing description, and all changes that come with the meaning and range of equivalency of the claims are intended to be embraced therein.

The matters described in the embodiments can be combined with each other. Also, the independent claims and dependent claims described in the claims can be combined with each other in any and all combinations regardless of the form in which they are cited. Furthermore, although the claims use a form in which a claim refers to more than one other claims (claim in multiple dependent form), the claims are not limited thereto. The claims may also be written using a form in which a multiple dependent claim refers to at least one multiple dependent claim (claim in multiple-multiple dependent form).

1. An in-vehicle device constituting a node of a communication system that performs data communication between nodes via a bus, comprising:
a communication unit configured to adjust a termination resistance value of a termination circuit,
wherein the communication unit includes:
a first termination circuit whose termination resistance value is constant; and
a second termination circuit whose termination resistance value is variable, and
the second termination circuit adjusts the termination resistance value to 0 Ω or a specific value.

2. (canceled)

3. The in-vehicle device according to claim 1, wherein the second termination circuit adjusts the termination resistance value to the specific value, in response to an adjustment instruction from outside when disconnection occurs in the communication system.

4. The in-vehicle device according to claim 3, wherein, when the in-vehicle device is disposed closer to a predetermined in-vehicle device that outputs the adjustment instruction than is a disconnection location within the communication system, the second termination circuit adjusts the terminal resistance value to the specific value in response to the adjustment instruction.

5. The in-vehicle device according to claim 1, wherein the termination resistance value of the first termination circuit is the same resistance value as the other in-vehicle devices.

6. A communication system comprising a plurality of in-vehicle devices that perform data communication via a bus,
wherein each in-vehicle device includes a communication unit configured to adjust a termination resistance value of a termination circuit,
one of the in-vehicle devices includes a storage unit configured to store connection situation information relating to a connection situation of the plurality of in-vehicle devices with respect to the bus,
the one in-vehicle device
specifies a disconnection location based on the connection situation information, when disconnection occurs in the communication system, and
outputs an instruction to adjust the terminal resistance value to another of the in-vehicle devices closer to the one in-vehicle device than is the disconnection location, and
the one in-vehicle device detects disconnection of the communication system, by determining whether data transmitted to the bus by the plurality of in-vehicle devices in response to a beacon signal is received, based on a predetermined order.

7. (canceled)

8. A communication stabilization method in a communication system including a plurality of in-vehicle devices that perform data communication via a bus and each include a communication unit configured to adjust a termination resistance value of a termination circuit, the method comprising:
specifying, with one of the in-vehicle devices, a disconnection location, based on connection situation information relating to a connection situation of the plurality of in-vehicle devices with respect to the bus, when disconnection occurs in the communication system;
outputting, with the one in-vehicle device, an instruction to adjust the termination resistance value to another of the in-vehicle devices closer to the one in-vehicle device than is the disconnection location;
adjusting, with the other in-vehicle device, the terminal resistance value in response to the instruction; and
detecting, with the one in-vehicle device, disconnection of the communication system, by determining whether data transmitted to the bus by the plurality of in-vehicle devices in response to a beacon signal is received, based on a predetermined order.

9. The in-vehicle device according to claim 3, wherein the termination resistance value of the first termination circuit is the same resistance value as the other in-vehicle devices.

10. The in-vehicle device according to claim 4, wherein the termination resistance value of the first termination circuit is the same resistance value as the other in-vehicle devices.
